(19) United States
(12) Patent Application Publication
(10) Pub. No.: US 2014/0063047 A1
(43) Pub. Date: Mar. 6, 2014

(54) DUOTONE EFFECT

(71) Applicants: Garrett M. Johnson, San Francisco, CA (US); Russell Y. Webb, San Jose, CA (US)

(72) Inventors: Garrett M. Johnson, San Francisco, CA (US); Russell Y. Webb, San Jose, CA (US)

(21) Appl. No.: 13/602,124

(22) Filed: Sep. 1, 2012

(51) Int. Cl. G09G 5/02

(52) U.S. Cl. 345/594; 345/593

(57) ABSTRACT

For an image editing application, a tool in a graphical user interface (GUI) for generating a duotone version of a subject image is provided. The tool includes several aligned thumbnail images in a slider, each thumbnail image occupying a spatial position in the slider that represents a unique range of colors. Each thumbnail image is a miniature version of the subject image that is generated based on a color within the unique range of colors represented by the spatial position of the thumbnail image. The tool determines a first color selection based on a position of a selector in the slider and a second color selection based on a complementary color of the first color selection. The tool then uses the determined color selections to generate a duotone version of the subject image.

### BACKGROUND

Traditional analog photography created specific looks associated with the actual image reproduction technique. Over the years, people have become accustomed to these looks, and actually enjoy the “artifacts” of the system. One such artifact in analog photography that many would like to recreate digitally is duotone effect.

Duotone images are usually created by superimposing two distinct colors on top of each other. In printing, this was accomplished by overlaying a single color of ink (typically black) with another color, such as blue or yellow. In analog photography, a cyanotype was the archetypical process used to create duotones. With cyanotypes, a single blue-tinted image was the default picture. This image could further be toned by adding other chemicals to the print to get color ranges from blue to yellow.

To recreate a duotone effect digitally, the user must first convert an image to a black-and-white representation, and then manually choose a color for the “bright” areas of the image and a color for the “dark” region. This is a manual process that requires skillful selection of two distinct tonal colors.

Therefore, there is a need for image editing or visual effects tools with intuitive user interfaces for digitally creating the traditional duotone effect. There is also a need for these visual effects tools to create the traditional duotone effect in a way that is as visually pleasing and as similar to the duotone effect in traditional analog photography as possible.

### SUMMARY

For an image editing application, some embodiments of the invention provide a tool in a graphical user interface (GUI) for generating a duotone version of a subject image. The tool includes several aligned thumbnail images in a slider, each thumbnail image occupying a spatial position in the slider that represents a unique range of colors. Each thumbnail image is a miniature version of the subject image that is generated based on a color within the unique range of colors represented by the spatial position of the thumbnail image. The tool determines a first color selection based on a position of a selector in the slider and a second color selection based on a complementary color of the first color selection. The tool then uses the determined color selections to generate a duotone version of the subject image.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 illustrates an example image editing application that provides a tool for generating a duotone image.

FIGS. 2a-2b illustrate the selection of highlight color and shadow color for generating duotone images.

FIGS. 3-5 illustrate the application of the duotone effect tool on a real photograph in a GUI.

FIG. 6 illustrates an image editing application that allows the user to make the duotone color selection by touching an image viewing area.

FIG. 7 conceptually illustrates a process performed by a duotone effect tool of an image editing application.

FIG. 8 illustrates a process for generating a series of thumbnail images at different 0 values of the color space.

FIG. 9 illustrates a process that applies a duotone effect to an image.

FIG. 10 illustrates a system that generates duotone images.

FIG. 11 illustrates an image editing application that applies different visual effects to an image.

FIG. 12 illustrates a detailed view of a GUI for viewing, editing, and organizing images.

FIG. 13 conceptually illustrates a data structure for an image as stored by the application of some embodiments.

FIG. 14 illustrates an example of an architecture of a mobile computing device that supports an image editing and viewing applications.

FIG. 15 conceptually illustrates another example of an electronic system with which some embodiments of the invention are implemented.

### DETAILED DESCRIPTION

In the following description, numerous details are set forth for the purpose of explanation. However, one of ordinary skill in the art will realize that the invention may be practiced without the use of these specific details. In other instances, well-known structures and devices are shown in block diagram form in order not to obscure the description of the invention with unnecessary detail.

### I. Duotone Effect

For an image editing application, some embodiments of the invention provide a tool in a graphical user interface (GUI) for generating a duotone version of a subject image. The tool includes several aligned thumbnail images in a slider, each thumbnail image occupying a spatial position in the slider that represents a unique range of colors. Each thumbnail image is a miniature version of the subject image that is generated based on a color within the unique range of colors represented by the spatial position of the thumbnail image. The tool determines a first color selection based on a position of a selector in the slider and a second color selection based on a complementary color of the first color selection. The tool then uses the determined color selections to generate a duotone version of the subject image.

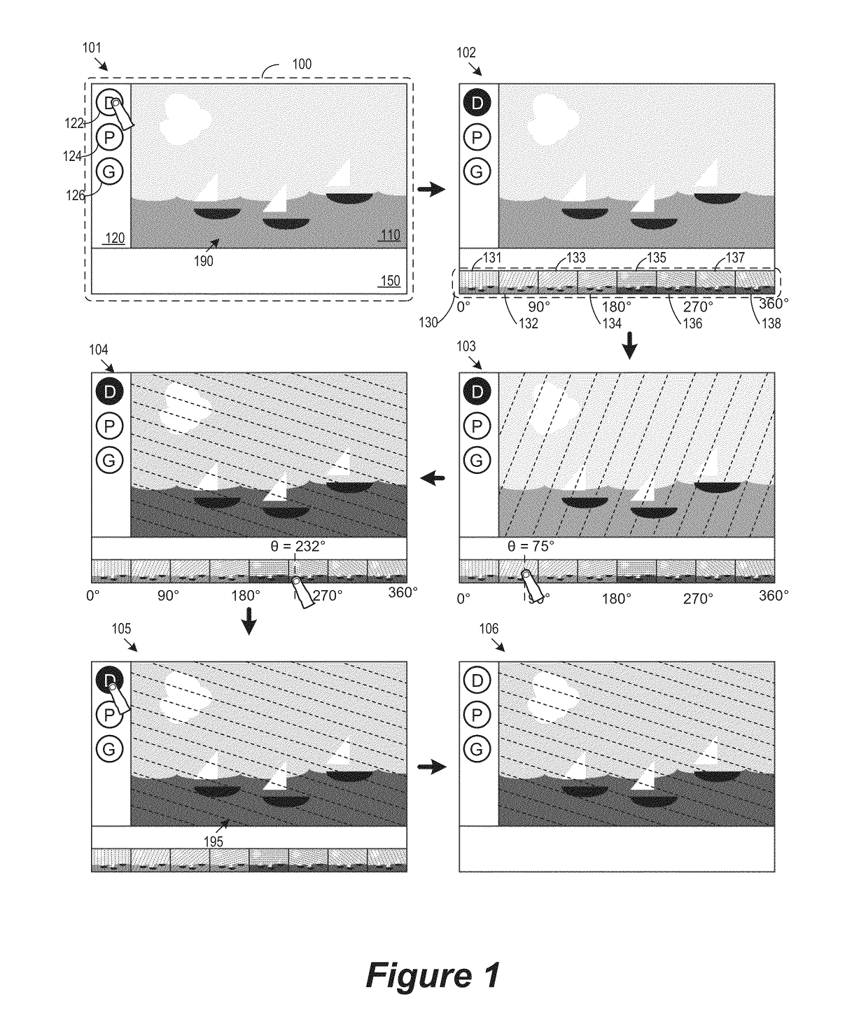

FIG. 1 illustrates an example image editing application that provides a tool for generating a duotone image. The image editing application includes a graphical user interface (GUI) 100 that support image editing operations based on several different image effects. As shown in the figure, the GUI 100 includes an image viewing area 110, an image effects menu area 120, and an image effects manipulation area 150. For purpose of illustration, FIG. 1 use superimposed hash patterns at different orientations to show duotone effects based on different angles in the color space. Any image illustrated in FIG. 1 as not having any superimposed hash pattern represents an image or photograph (colored or otherwise) without duotone effect.

The image viewing area 110 allows the user to view the current state of the image being processed. In some embodiments, the image editing application displays an image in its original form inside the image viewing area 110 when the image is loaded from a storage medium into the application. Once a particular effect has been applied by the user, the user can view the resulting image due to the effect on the image viewing area 110. In this example, the image 190 is loaded into the image editing application and the user can view the image and the effects applied upon it in the image viewing area 110.

The image effects menu area 120 includes a number of items that allow the user to activate various image effect tools. In the example of FIG. 1, the image effects menu 120 includes a duotone effect activation item 122, a painterly effect activation item 124, and a grain effect activation item 126. The duotone effect activation item 122, when selected, activates the duotone effect tool that allows the user to apply a duotone effect on the image 190. Likewise, the painterly effect activation item 124 and the grain effect activation item activate tools that allow the user to apply a painterly effect and a grain effect, respectively, to the image 190. In some embodiments, an activation item such as the duotone activation item 122 changes its appearance (e.g., become highlighted or changes color) when selected.

The image effects manipulation area 150 allows the user of the image editing application to input additional parameters for a given image effect operation. When one of the activation items (122, 124, or 126) is selected in the image effects menu area 120, one or more UI items such as buttons, sliders, or dialogue boxes related to that particular activation item, can appear in the image effects manipulation area 150. The user can manipulate these UI items to provide additional parameter specifications to the image editing application. For example, when the duotone effect activation item 122 is selected, a duotone color selection slider 130 would appear in the image effects manipulation area 150 so the user can specify which color(s) to use for the duotone image. In some embodiments, the slider 130 does not appear in the GUI 100 until the duotone effect operation has been selected (e.g., by selecting the duotone effect activation item 122).

The duotone color selection slider 130 has the appearance of a filmstrip that is populated by thumbnail images 131-138 of the original subject image 190. Each thumbnail image occupies a slot in the slider 130 that encompasses a range of colors that are contiguous in a color space. Each thumbnail image is a miniaturized sample duotone image that is based on a color within the color range that corresponds to the thumbnail's slot. In some embodiments, this is the color in the middle of the range of colors (i.e., represented by the center of the slot). One of ordinary skill would recognize that other colors in the color range encompassed by the thumbnail slot can also be used to generate the duotone thumbnail image.

Positions between the two ends of the slider 130 linearly and continuously represent different colors in the color space. The color space can be defined under many different color space conventions, such as RGB, YCrCb, and YIQ. YCrCb and YIQ are color space conventions that use the luminance component (Y) and chrominance components (CrCb or IQ) to represent colors. For some embodiments that use luminance and chrominance components, the chrominance components can be represented by radius r and angle θ in the color space. The r parameter is the colorfulness of a color relative to its own brightness, and is referred to as strength or saturation in some embodiments. The θ parameter specifies the color along a circle (with radius r) in the color space. For some embodiment that uses the YCrCb convention, the chrominance components Cr and Cb are parametrized as r and θ:

Cr=r sin(θ) and Cb=r cos(θ) (1).

For some embodiment that uses the YIQ convention, the chrominance components I and Q are likewise parametrized as r and θ:

I=r sin(θ) and Q=r cos(θ) (2).

In some embodiments, to specify a color is to specify an angle θ in the color space. Given an image (whether it's full-sized subject image or a miniaturized thumbnail image), some embodiments generate a duotone version of the image based on a specified angled θ. The slider 130 is used for specifying a color selection for generating a duotone version of a subject image, as positions between the two ends of the slider 130 linearly and continuously represent different angle θ in the color space. A thumbnail duotone image is generated based on an angle θ in the color space that falls within the thumbnail's slot. A user specifies a color for generating the final duotone image by using the slider 130 to specify an angle θ.

In some embodiments, a duotone image is created by mixing a highlight image and a shadow image. The highlight image is generated by applying a highlight color to the brighter regions of the subject image while the shadow image is generated by applying a shadow color to the darker regions of the subject image. In some embodiments, the highlight color is defined to be the specified angle θ while the shadow color is defined to be the compliment of the specified angle (i.e., θ+180° or θ−180°.

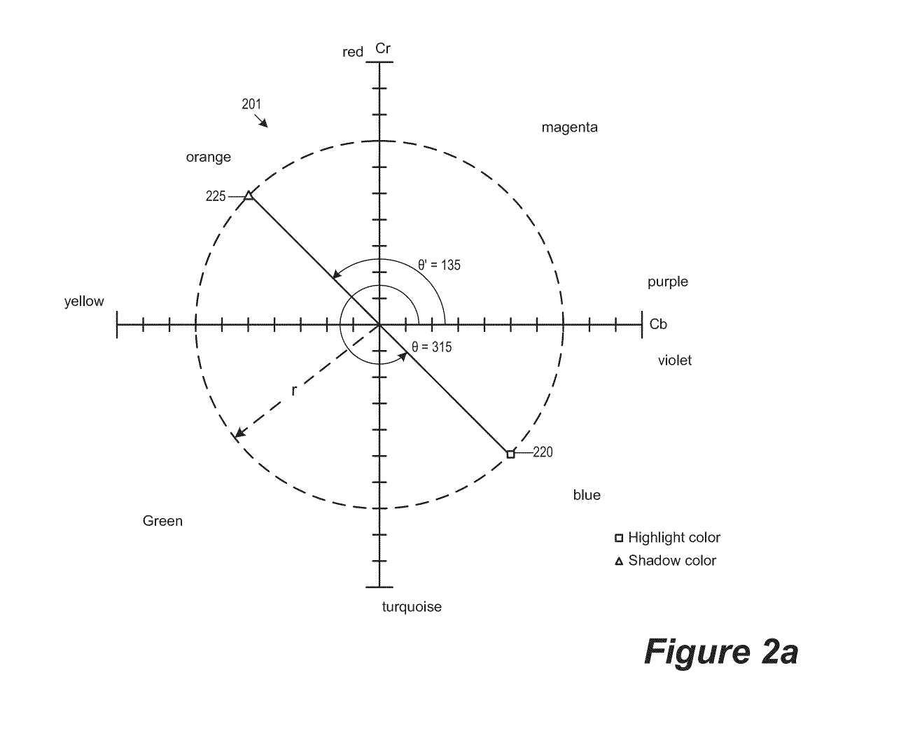

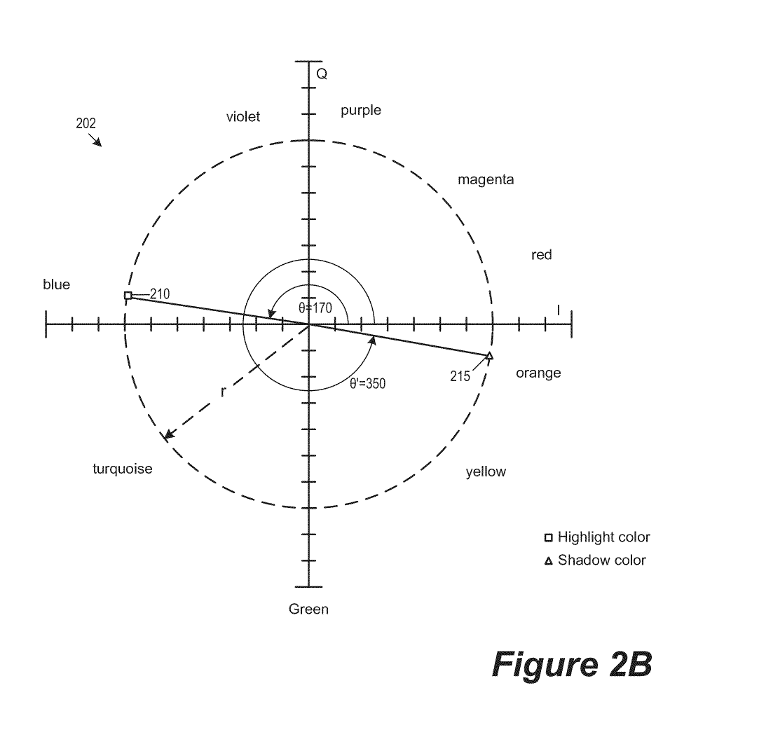

FIGS. 2a illustrates the selection of the highlight color and shadow color in the color space for generating duotone images. FIG. 2a illustrates a color space 201 under the YCrCb convention, in which different regions represent different colors such as purple, magenta, red, orange, yellow, green, turquoise, blue, and violet. Chrominance components of a pixel can be expressed in rectangular coordinates (Cb, Cr), in which the vertical coordinate corresponds to red-difference chrominance component Cr while the horizontal coordinate corresponds to the blue-difference chrominance component Cb. Chrominance components can also be expressed in angular coordinates (r, θ), in which the radius r represents the saturation while the angle θ specifies different colors.

A color selection of θ=315° defines a highlight color selection 220 (indicated by a small square) and a shadow color selection 225 (indicated by a small triangle). Specifically, the highlight color selection correspond to the angle θ=315° (which correspond to blue) while the shadow color correspond to the complementary angle θ′=315°−180°=135° (which correspond to orange).

The example illustrated in FIG. 2a is based on a specified angle θ in a YCrCb color space. FIG. 2b illustrates the selection of the highlight color and shadow color in a YIQ color space 202, in which the vertical coordinate corresponds to quadrature chrominance component Q while the horizontal coordinate corresponds to the in-phase chrominance component I. A color selection of θ=170° defines a highlight color selection 210 (indicated by a small square) and a shadow color selection 215 (indicated by a small triangle). Specifically, the highlight color selection correspond to the angle θ=170° (which correspond to blue) while the shadow color correspond to the complementary angle θ′=170°+180°=350° (which correspond to orange).

Returning to FIG. 1, as mentioned above, the slider 130 is populated by thumbnails of duotone images. These thumbnails are generated at different θ along a circle defined by a given r (strength/saturation) in the color space. As illustrated, the left end of the slider represents 0° or On in the color space. The right end of the slider represents 360° or 2π in the color space. Each thumbnail represents a contiguous range in the color space, and positions within a thumbnail continuously represent different color selections within that contiguous range. Since there are eight thumbnail images (131-138) in the slider 130, each thumbnail represents 1/8 of the color space. Specifically, thumbnail 131 corresponds to a range from 0° to 55°, thumbnail 132 corresponds to a range from 55° to 90°, thumbnail 133 corresponds to a range from 90° to 135°, thumbnail 134 corresponds to a range from 135° to 180°, thumbnail 135 corresponds to a range from 180° to 225°, thumbnail 136 corresponds to a range from 225° to 270°, thumbnail 137 corresponds to a range from 270° to 315°, and thumbnail 138 corresponds to a range from 315° to 360°. For some embodiments that generate each thumbnail image based on the θ that corresponds to its center, the thumbnail 131 is generated based on θ=22.5°, the thumbnail 138 is generated based on θ=337.5°, etc.

Though not illustrated, some embodiments allow the user to zoom-in on the slider so that the displayed slider represents only a portion of the 0-360° color space. In some of these embodiments, each thumbnail image in the slider represent a smaller range in the color space, and the positions within the thumbnail continuously represents different colors within that smaller range at a granularity that is finer than the granularity of the full scale slider illustrated in FIG. 1.

The saturation/strength parameter r of the equations (1) and (2) is set to a fixed value in some embodiments. For example, some embodiments set the parameter r at 0.1. In some embodiments, the saturation/strength parameter r is adjustable by the user through the GUI. For example, some embodiments provide a slider in the image effects manipulation area 150 for setting the value of r.

FIG. 1 illustrates the generation of a duotone image in six different stages 101-106. The first stage 101 shows the GUI 100 and the image 190 before the application of the duotone effect. The image 190 has been loaded into the image editing application and is being displayed in the image viewing area 110. The image 190 can be an original source image that has not been altered by any effect. The image 190 can also be an image that has one or more effects already applied. None of the activation items in the image effects menu area 120 menu is highlighted, indicating that none of the image effects is currently selected. The image effects manipulation area 150 does not display any UI items specific to any of the image effects tools available in the image effects menu 120. However, the user is selecting (e.g., by touching a touch screen) the duotone activation item 122 for activating the duotone effect tool.

The second stage 102 illustrates the GUI 100 after the selection of the duotone activation item 122 by the user. The duotone activation item 122 is highlighted, indicating that the duotone effect tool has been selected and the image editing application is in a mode that allows the user to apply a duotone effect to the image 190. The activation of the duotone effect tool causes the duotone color selection slider 130 to appear in the image effects manipulation area 150 of the GUI 100.

The third stage 103 illustrates using the slider 130 to navigate the color space. Specifically, the user is illustrated as making a selection (e.g., by touching the touch screen) within the thumbnail image 132 in the slider 130. The exact position of the user's selection corresponds to a color selection of θ at 75°. A preview of the duotone image based on the θ (75°) is provided in the image viewing area 110. Some other embodiments use other areas in the GUI 100 (such as a pop-up window) for providing such a preview.

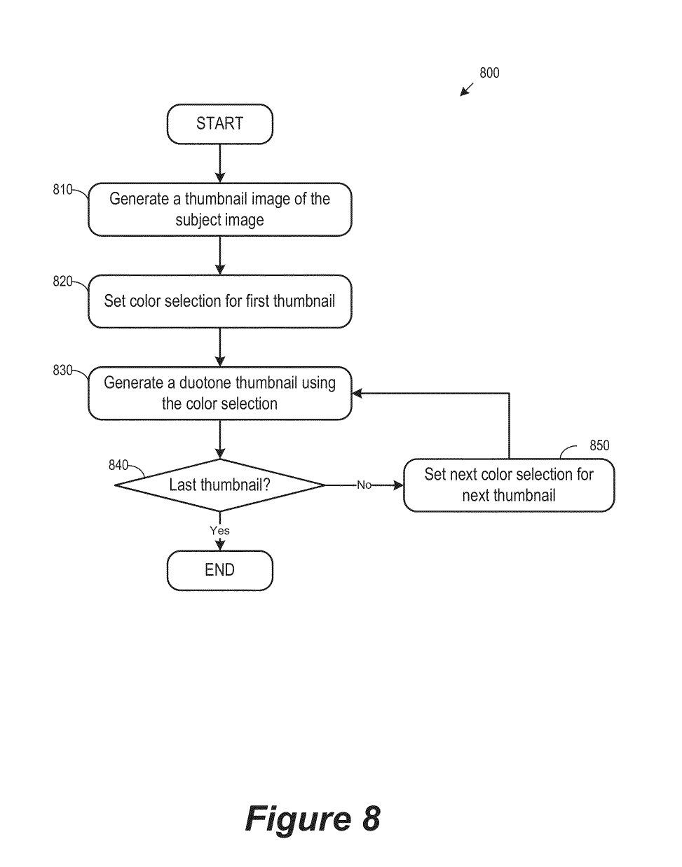

The fourth stage 104 illustrates using the slider 130 to navigate to another color in the color space (θ=232°. In both stages 103 and 104, the image editing application uses the θ specified by the user through the use of the slider 130 to generate duotone images. The generation of a duotone image based on a specified angle θ in the color space will be further described below by reference to FIGS. 8-10.

The fifth stage 105 illustrates the completion of the duotone effect operation applied to the image 190. The image viewing area 110 shows the image 195, which is the image 190 with the duotone effect applied (based on the last color selection, i.e., θ=232°. However, the duotone activation item 122 remains highlighted to indicate that image editing application is still in the mode that allows the user to apply a duotone effect. The slider 130 remains visible in the GUI 100 so the user can continue to use the slider 130 to find a suitable θ for generating the duotone effect for the image 190. However, the user is de-selecting (e.g., by touching the touch screen) the duotone effect activation item 122, indicating that the user is ready to accept the duotone effect that has been applied to the image 190 and quit the duotone image generation operation.

The final stage 106 illustrates the GUI 100 after the de-selection of the duotone activation item 122. The duotone activation item 122 is no longer highlighted, indicating that it has been unselected. The unselecting of the duotone activation item 122 causes the disappearance of the duotone selection slider 130 in the image effects manipulation area 150. The image 195 in the image viewing area 110 now includes the duotone effect (at θ=232°. The user is now free to apply other effects on the image 195 in addition to the duotone effect just applied.

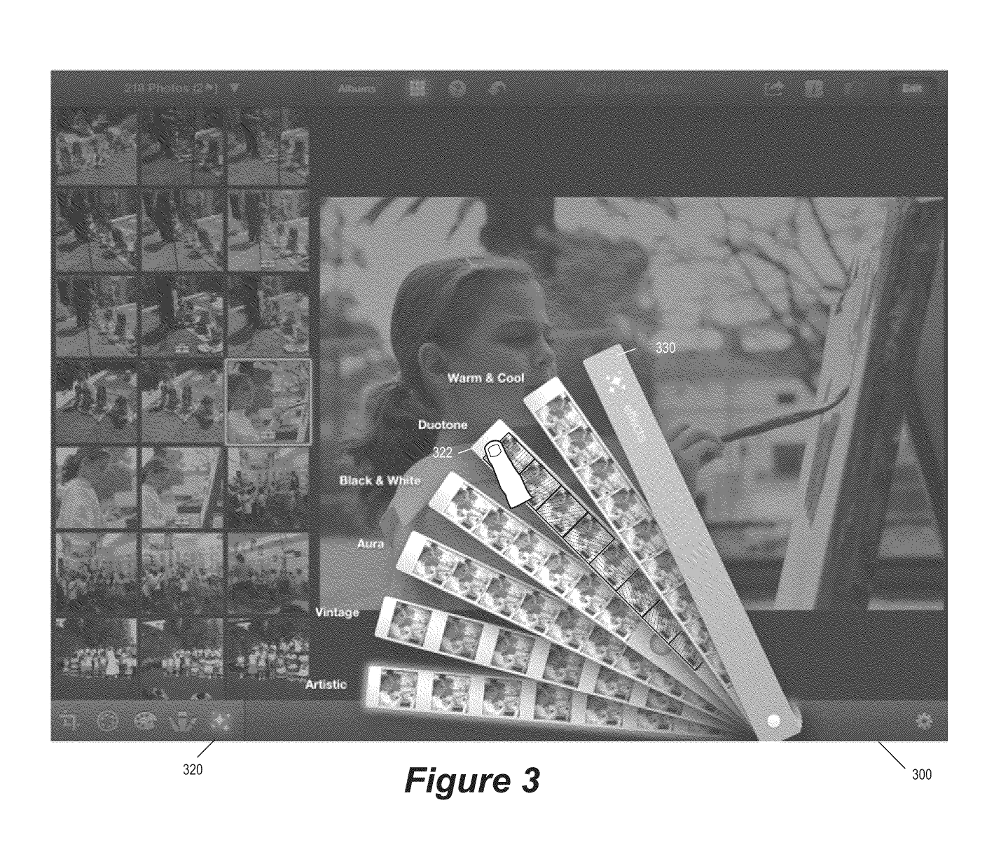

FIGS. 3-5 illustrate the application of the duotone effect tool on a real photograph in a GUI 300. FIG. 3 shows the activation of the duotone effect tool. An effects item 320 has been selected, and several activation items for various different image effects appear as a set of items that fan out from a tool bar 330 that includes “Warm & Cool”, “Duotone”, “Black & White”, “Aura”, “Vintage”, and “Artistic”. From among these activation items, the user is selecting an activation item 322 for duotone. For purpose of illustration, FIGS. 3-5 use superimposed hash patterns at different orientations to show duotone effects based on different angles in the color space. Any image illustrated in FIGS. 3-5 as not having any superimposed hash pattern represents an image or photograph (colored or otherwise) without duotone effect.

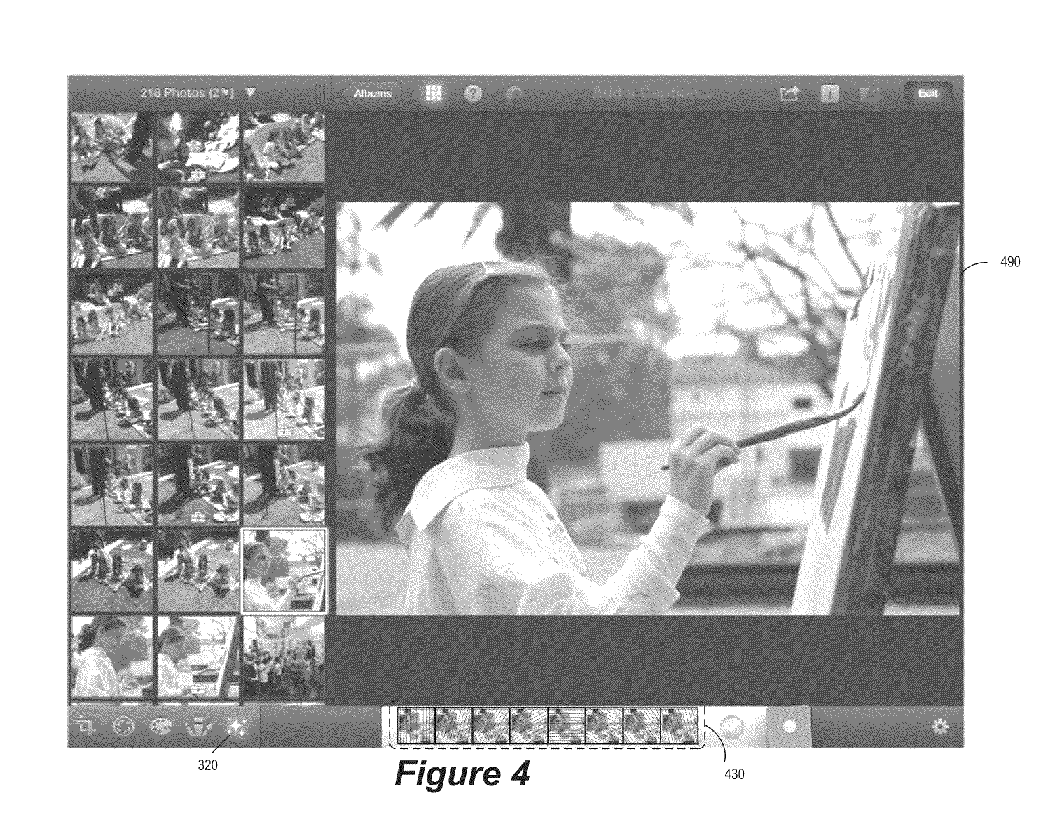

FIG. 4 shows a duotone color selection slider 430 that appears in the GUI 300 after the selection of the duotone effect activation item 322. The duotone color selection slider is generated based on the real color photograph 490. The duotone color selection slider 430 is a filmstrip of duotone thumbnails of the photograph 490 at eight different angles (A) of the color space.

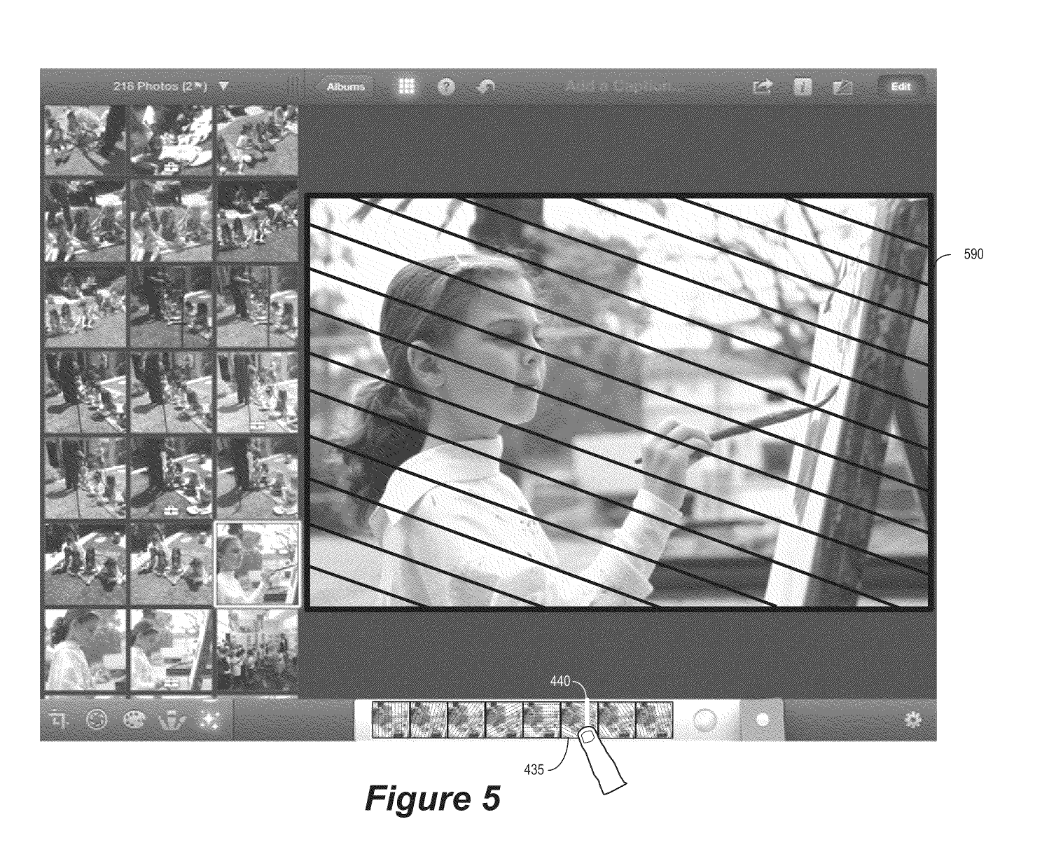

FIG. 5 illustrates a duotone image 590 that is the duotone version of the original color photograph 490. The duotone image 590 is based on a color selection by the user. The user makes the color selection by selecting a position in the slider 430. The position in the slider is as indicated by a selection needle 440 in the thumbnail 435. The user can move the selection needle 440 to another position within the thumbnail 435 to select another color that is within the range of colors represented by the thumbnail 435. The user can also move the needle 440 to a position within another thumbnail in the slider 430.

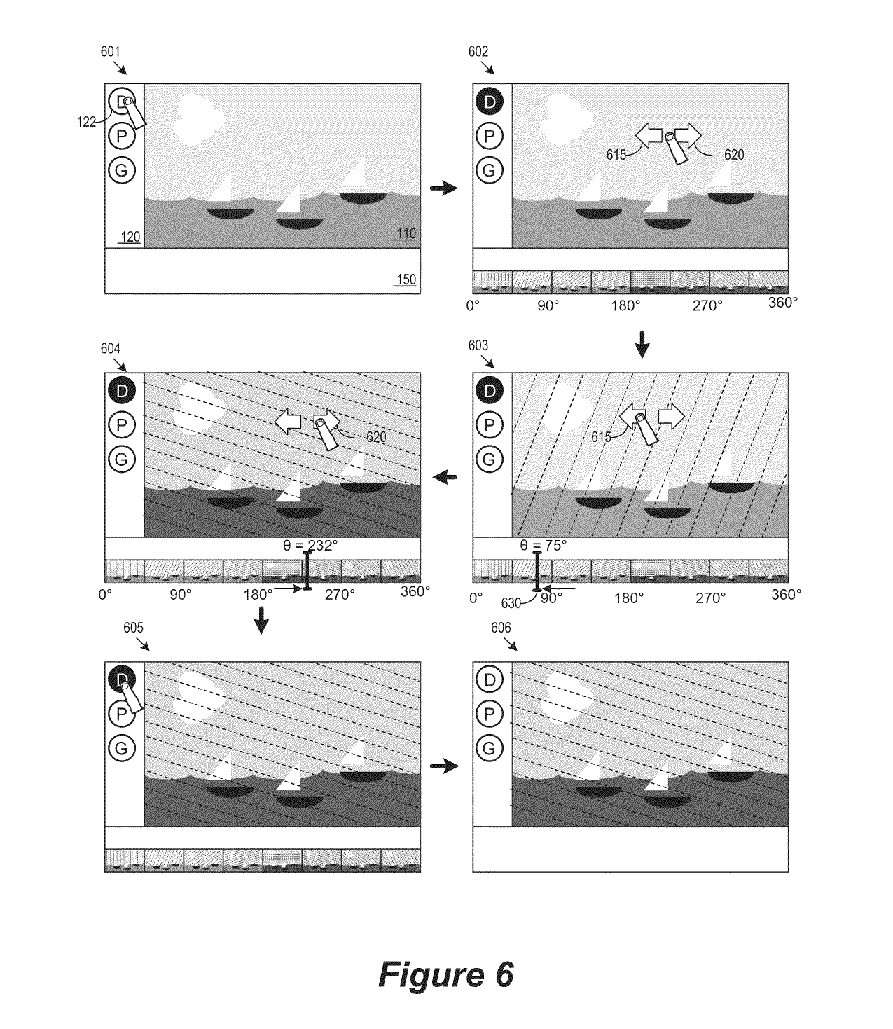

Instead of touching the duotone color selection slider (e.g., the slider 130 of FIG. 1 or the slider 430 of FIG. 4), some embodiments allow duotone color selection by touching the image (in the image viewing area 110) itself. FIG. 6 illustrates the image editing application allowing the user to make the color selection by touching the image viewing area 110. This operation is illustrated in six stages 601-506 of the GUI 100. For purpose of illustration, FIG. 6 uses superimposed hash patterns at different orientations to show duotone effects based on different angles in the color space. Any image illustrated in FIG. 6 as not having any superimposed hash pattern represents an image or photograph (colored or otherwise) without duotone effect.

The first stage 601 is identical to the first stage of FIG. 1, in which the user is about to select the duotone effect activation item 122. The second stage 602 shows that the duotone effect tool has been activated and the duotone color selection slider 130 has appeared in the image effects manipulation area 150. However, instead of touching the filmstrip in the slider 130, the user touches the image in the image viewing area 110, which causes a set of on-image UI controls 615 and 620 (displayed as two directional arrows along the horizontal axis) to appear for making color selections.

At the third stage 603, the user touches the on-image UI control 615 (the left arrow), which causes a selection needle 630 above the slider 130 to move leftward to a position that corresponds to the color at θ=75°. The image in the image viewing area 110 accordingly shows a duotone image that is generated based on the 75° color selection. In the fourth stage, 604, the user likewise touches the on-image UI control 620 (the right arrow), which causes the selection needle 630 to move rightward to a position that corresponds to the color at θ=232°. The image in the image viewing area 110 accordingly shows a duotone image that is generated based on the 232° color selection.

At the fifth stage 605, the user ceases touching the image, and the on-image UI controls 615 and 620 disappear from the image view area 110. The user is de-selecting (e.g., by touching the touch screen) the duotone effect activation item 122, indicating that the user is ready to accept the duotone effect that has been applied to the image 190 and quit the duotone image generation operation. The sixth and final stage 106 illustrates the 100 GUI after the de-selection of the duotone activation item 122. The image 195 in the image viewing area 110 now includes the duotone effect (at θ=232°.

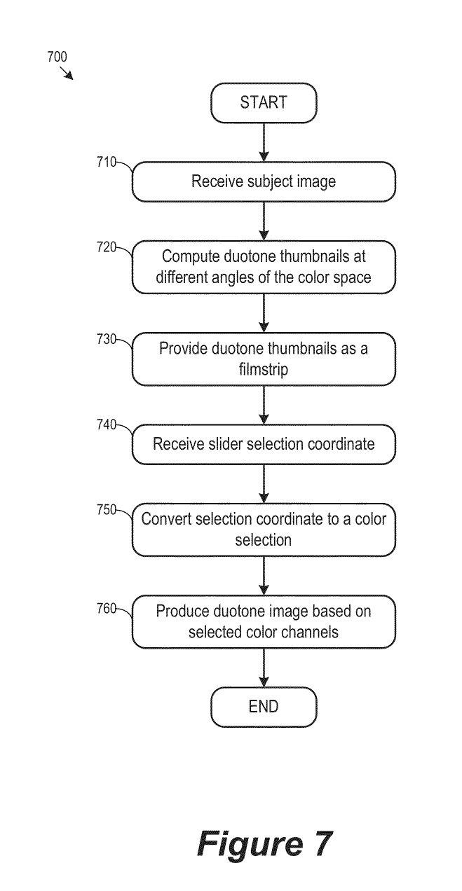

For some embodiments, FIG. 7 conceptually illustrates a process 700 performed by a duotone effect tool of the image editing application. The process 700 can be used to provide the duotone thumbnail images in the slider 130 and the resulting duotone image 195 of FIG. 1.

The process 700 starts when the image editing application receives a command to activate the duotone effect tool. In the example of FIG. 1, the command to activate the duotone effect tool is received when the duotone effect activation item 122 is selected by the user.

The process 700 receives (at 710) a subject image for the duotone effect. Based on this subject image, the process next computes (at 720) duotone thumbnails at different angles (0) of the color space. In some embodiments, the process generates each duotone thumbnail of the subject image at a predetermined increment so the slider populated by the thumbnails covers angles from 0° to 360°. In the example of FIG. 1, the process generates eight duotone thumbnails of the image 190 at 55° increment (360°/8=55°). Specifically, the process generates the duotone thumbnails 131-138 at θ=22.5°, 67.5°, 112.5°, 157.5°, 202.5°, 247.5°, 292.5Z°, and 337.5°. After generating the thumbnails of the subject image, the process provides (at 730) the thumbnail images as a filmstrip to populate a slider (such as the slider 130). FIG. 8 below illustrates a process for generating the duotone thumbnails in the slider.

The process next receives (at 740) a slider selection coordinate. In some embodiments, the GUI of the image editing application provides this coordinate to the process 700 when the user makes a selection (e.g., by touching the screen, by clicking the mouse, etc.,) within the slider. The coordinate of the selection (e.g., the position of the contact point by the finger, the position of the cursor, etc.,) is reported and received by the process 700.

The process then converts (at 750) the received coordinate into a color selection. Some embodiments make this conversion based the coordinate's position within the slider. For example, a selection coordinate that is halfway between the start and the end of the slider will be converted to a color selection of 180° (since the start of the slider is 0° and the end of the slider is 360°), and the selection coordinate that is 75% of the way from the start of the slider will be converted to a color selection of 270°. The process next produces (at 760) a duotone image based on the color selection. After producing the duotone image, the process 700 ends.

FIG. 8 illustrates a process 800 for generating a series of thumbnail images at different θ values of the color space for some embodiments. Specifically, the process 800 generates duotone thumbnails of the subject image at a predetermined increment so the slider populated by the thumbnails covers angles from 0° to 360°.

The process 800 starts when it receives a subject image from the image editing application. The process generates (at 810) a thumbnail image of the subject image. In some embodiments, this is accomplished by down sampling the subject image into a smaller image.

The process next sets (at 820) a first color selection for the first thumbnail. This first color selection can be arbitrarily chosen to be any value between 0° and 360°. In the example of FIG. 1, the first color selection for the first thumbnail is chosen to be 0=22.5° so the left side of the first thumbnail 131 is aligned with 0° and the right side of the last (e.g., the eighth) thumbnail can be aligned with 360°. Some other embodiments do not align the first thumbnail with 0° and are free to set the first color selection to any angle θ in the color space.

The process then generates (at 830) a duotone thumbnail using the color selection that was set in 820. The duotone thumbnail is the duotone version of the thumbnail image generated at 810. The process next determines (at 840) whether the thumbnail that has just been generated is the last thumbnail. The last thumbnail in some embodiments is the thumbnail that covers a color range that is adjacent to or is overlapping the color range of the first thumbnail. If the generated thumbnail is the last thumbnail, the process 800 ends. Otherwise, the process proceeds to 850.

At 850, the process sets the next color selection for the next thumbnail. Some embodiments increment the color selection θ by an increment value 360°/N, N being the number of thumbnails that is to be generated. In the example of FIG. 1, N is 8 and the increment value is 45° (i.e., 360°/8). Some embodiments allow the incremented value to exceed or wrap around 360° if the first thumbnail is not aligned to 0°. After setting the next color selection for the next thumbnail the process proceeds back to 830 to generate another duotone thumbnail based on this next color selection.

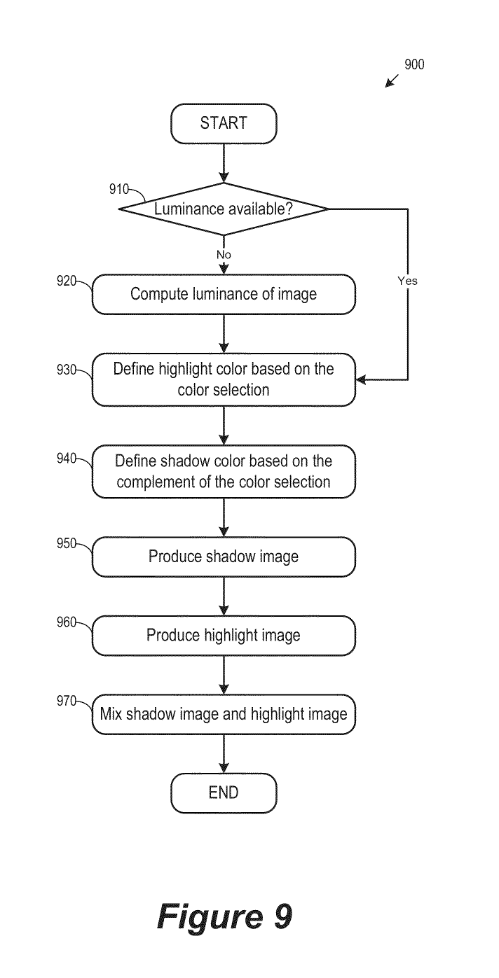

FIG. 9 illustrates a process 900 that applies the duotone effect on an image for some embodiments. Such an image can be the subject image being edited (e.g., 190) in the image editing application or a thumbnail version of the subject image. Once given a single color selection (e.g., from a single color selection slider such as the slider 130), the processes 900 creates a duotone version of the image by using the given color selection as a highlight color and a complementary color of the given color selection as a shadow color. In some embodiments, this process 900 is used for generating both the duotone thumbnails and the final duotone image.

The process determines (at 910) whether luminance components are available. For an image that is coded using YCrCb or YIQ, the luminance component is already available since it is the Y component. For images that do not directly encode luminance components (such as RGB encoded images), the process must first compute the luminance component of the image. If the luminance component is already available, the process proceeds to 930. If not, the process proceeds to 920.

The process computes (at 920) luminance components of the image. For an image that is encoded by using RGB coding, the luminance component Y can be computed from the red component R, the green component G, and the blue component B as:

Y=R*0.299+G*0.587+B*0.144 (3).

The process next defines (at 930) a highlight color based on the given color selection. The process also defines (at 940) a shadow color based on the complementary color of the given color selection. For a given color selection θ, the complementary color is set to the color that is at 180° from θ (θ+180° or θ−180°) in the color space. In other words, for a given color selection with chrominance (I₁, Q₁), the complementary color has chrominance (I₂, Q₂) that is equal to (−I₁, −Q₁). Using a given color selection θ to define the highlight color and the shadow color is described above by reference to FIG. 2.

Next, the process produces (at 950) a shadow image. The shadow image is produced in some embodiments by applying the chrominance components of the complementary color (i.e., I₂, Q₂) to the shadow or darker regions of the image. In some embodiments, the chrominance of the shadow image is computed as:

Shadow IQ=(1.0−Y)*(I₂, Q₂) (4),

where (I₂, Q₂) is the chrominance of the shadow/complementary color, and luminance Y is normalized to between 0.0 and 1.0, where 0.0 represents the darkest color (black) and 1.0 represents the brightest color (white).

The process then produces (at 960) a highlight image. The highlight image is produced in some embodiments by applying the chrominance components of the highlight color (i.e., I₁, Q₁) to the brighter regions of the image (i.e., regions with a normalized luminance value Y closer to 1.0). In some embodiments, the chrominance of the highlight image is computed as:

Highlight IQ=Y*(I₁, Q₁) (5),

where (I₁, Q₁) is the chrominance of the highlight color.

The process then mixes (at 970) the shadow image and the highlight image to produce the final duotone image. In some embodiments, this is done by adding the shadow image to the highlight image. Thus, the chrominance of the duotone image is computed as:

Duotone IQ=Y*(I₁, Q₁)+(1.0−Y)*(I₂, Q₂) (6).

The resulting duotone image is simply an image with the computed chrominance component “Duotone IQ” from equation (6) and the same luminance component Y from the original image. After mixing the shadow image and the highlight image to produce the duotone image, the process 900 ends.

In some embodiments, the operations 940-970 are not performed as distinct operations. Once given a single color selection, some of these embodiments generate the final duotone image in one mathematical operation. Specifically, once given a subject image with luminance component Y and a color selection θ, some embodiments produce a duotone image with luminance component Y and chrominance components “Duotone IQ” calculated according to:

Duotone IQ=Y*(r sin θ, r cos θ)+(1.0−Y)*(−r sin θ, −r cos θ) (7),

which can be simplified as:

Duotone IQ=[(2Y−1)(r sin θ), (2Y−1)(r cos θ)] (8).

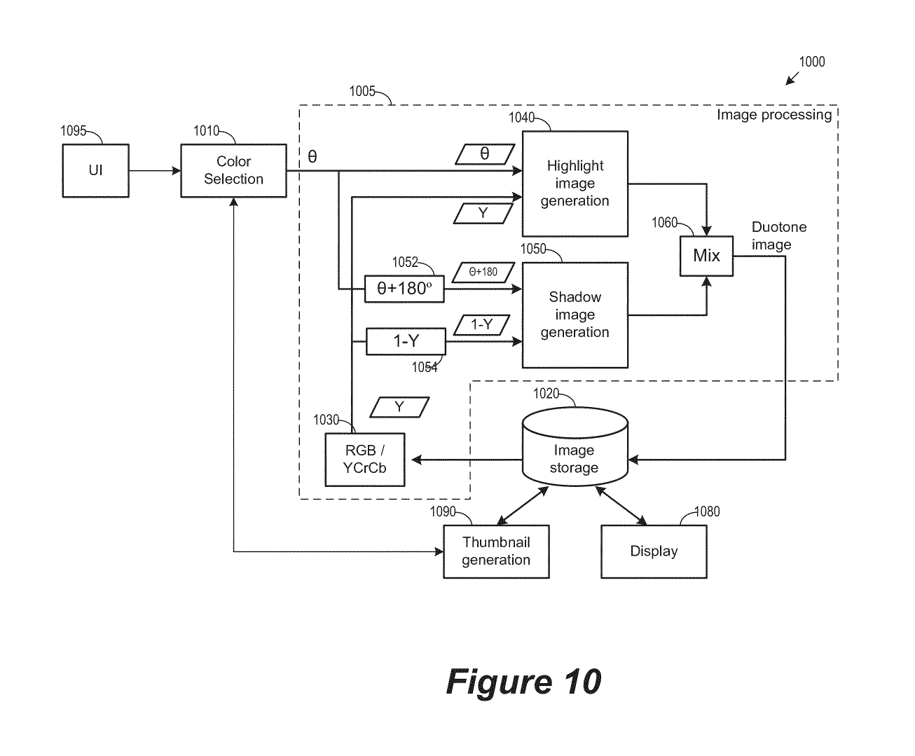

FIG. 10 illustrates a system 1000 that generates duotone images for some embodiments. The system is capable of generating duotone images of the original subject image as well as thumbnails in a filmstrip (such as in the duotone color selection slider 130). In some embodiments, the system 1000 is a computing device that performs the processes 700, 800, and 900 in FIGS. 7-9.

The system 1010 includes an image processing module 1005, a color selection module 1010, an image storage 1020, a display module 1080, and a thumbnail generation module 1090. The image processing module 1005 generates a duotone image based on a subject image received from the image storage 1020 and a color selection received from the color selection module 1010. The color selection module receives color specifications from a user interface (UI) 1095 and the thumbnail generation module 1090.

The image processing module 1005 includes a color space conversion module 1030, a highlight image generation module 1040, and a shadow image generation module 1050. The color space conversion module 1030 converts pixels from a subject image coded in another color space (such as RGB) into a color space that has a luminance component such as YCrCb or YIQ. The color space conversion module 1030 then extracts the luminance component (Y) from the converted image and sends it to the highlight image generation module 1040 and the shadow image generation module 1050.

The highlight image generation module 1040 creates a highlight image by applying the color selected (θ) from the color selection module 1010. The shadow image generation module 1050 creates a shadow image by applying the complement color of the color selected by the UI 1010 (θ+180° or θ−180°. In some embodiments, the highlight image is generated according to the equation (5) and the shadow image is generated according to the equation (4). An image mixer 1060 then mixes the highlight image and the shadow image to form the duotone image. In some embodiments, the generation of the duotone image out of highlight and shadow images is done according to the equation (6). The generated duotone image is then stored in the image storage 1020.

The image storage 1020 can be one or more physical storage devices for storing images involved in the duotone image generation operation. The image storage 1020 provides the subject image to the image processing module 1005 and stores the resulting duotone image. The images stored in the image storage 1020 are provided to the display module 1080 to be viewed by the user in a GUI.

The system 1000 also facilitates the creation of the duotone color selection slider (such as 130 of FIG. 1). The thumbnail generation module 1090 retrieves the subject image from the image storage and creates a thumbnail version of the subject image (e.g., by down-sampling the subject image). The created thumbnail image is then stored back into the image storage 1020. Based on the retrieved thumbnail image, the thumbnail generation module 1090 controls the color selection module 1010 to output several different color selections to the image processing module 1005 for creating a series the duotone thumbnails. The duotone thumbnails are in turn stored in the image storage 1020 and displayed as a filmstrip in the color selection slider.

### II. Software Architecture

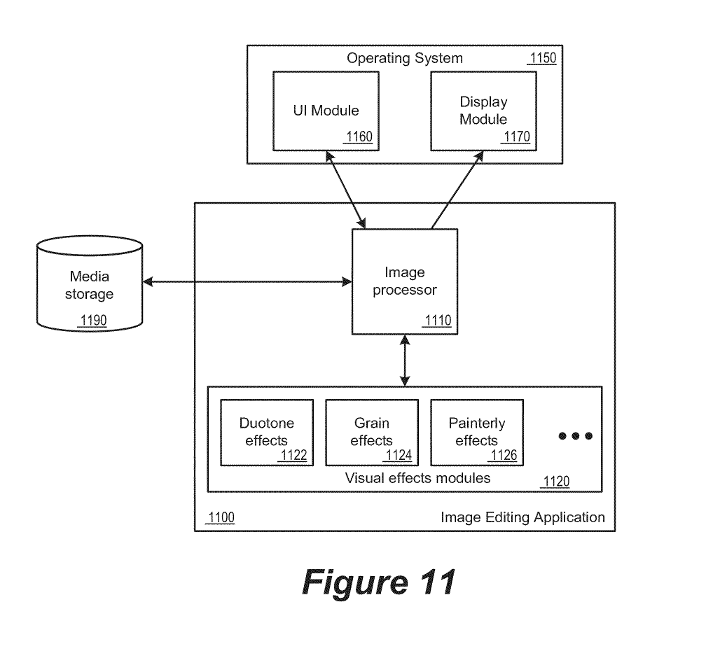

FIG. 11 illustrates an image editing application 1100 of some embodiments that applies different visual effects to an image, including visual effects such as a duotone effect, a grain effect, and a painterly effect. As shown in FIG. 11, the image editing application 1100 includes an image processor 1110 and visual effects module 1120. The visual effects module 1120 includes various specialized modules such as a duotone effects module 1122, a grain effects module 1124, and a painterly effects module 1126. The image processor 1110 interfaces with modules in the operating system 1150, including modules such as a UI module 1160 and a display module 1170. The image editing application 1100 also accesses a media storage 1190 for image storage and retrieval.

The image processor 1110 retrieves images from the media storage 1190 and uses the visual effects modules 1120 to apply image effects to the retrieved images. When a user invokes a particular visual effects tool for a particular image, the UI module 1160 informs the image processor 1110. The image processor then retrieves the particular image from the media storage 1190, applies the visual effects by using visual effects modules 1120, and stores the altered image in the media storage 1190. The image processor 1110 also provides the images (before and/or after the visual effect) to the UI module 1160 and the display module 1170 to be displayed as part of a GUI.

When the duotone effect tool is invoked (e.g., by selecting the duotone effect activation item 122), the image processor 1110 performs the duotone operation by using the duotone effects module 1122 to apply the duotone effect and to create the thumbnail filmstrip. The color selection is supplied by the UI module 1160. The duotone thumbnails as well as the image with the applied duotone effect will be sent to the display module 1170 for display. In some embodiments, the duotone effects module performs the processes 700, 800, and 900. In some embodiments, the duotone effects module includes the image processing module 1005 of FIG. 10.

### III. Image Viewing, Editing, and Organization Application

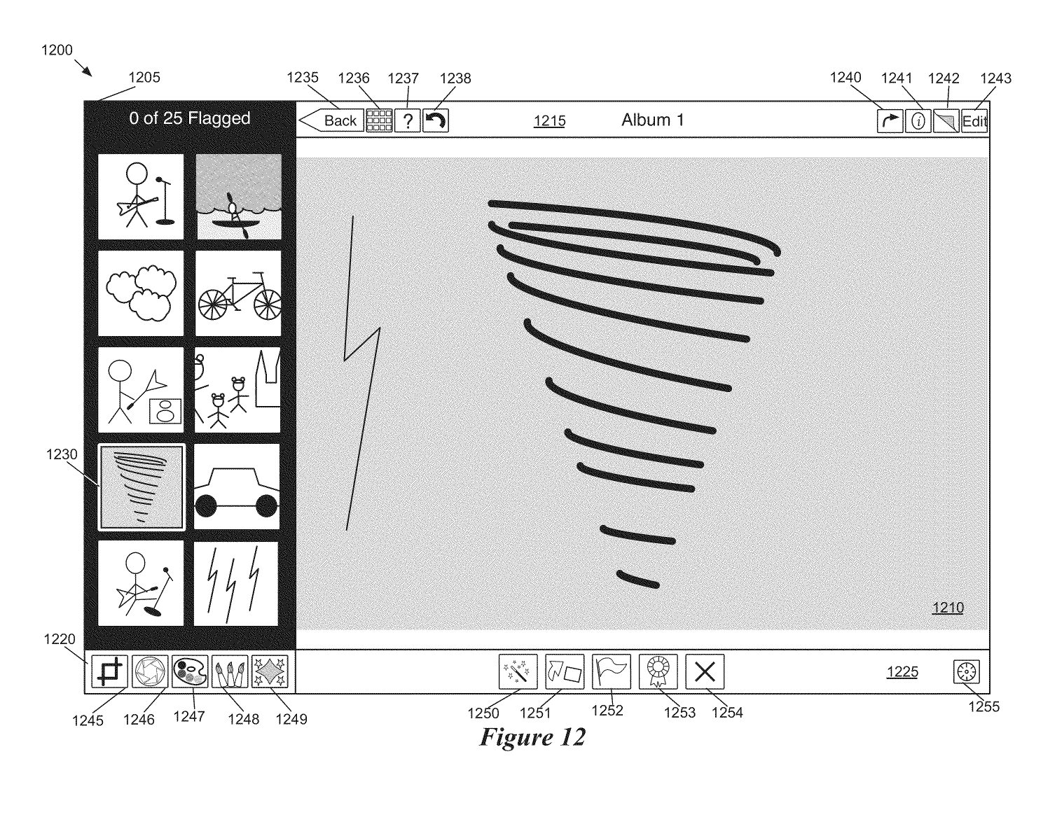

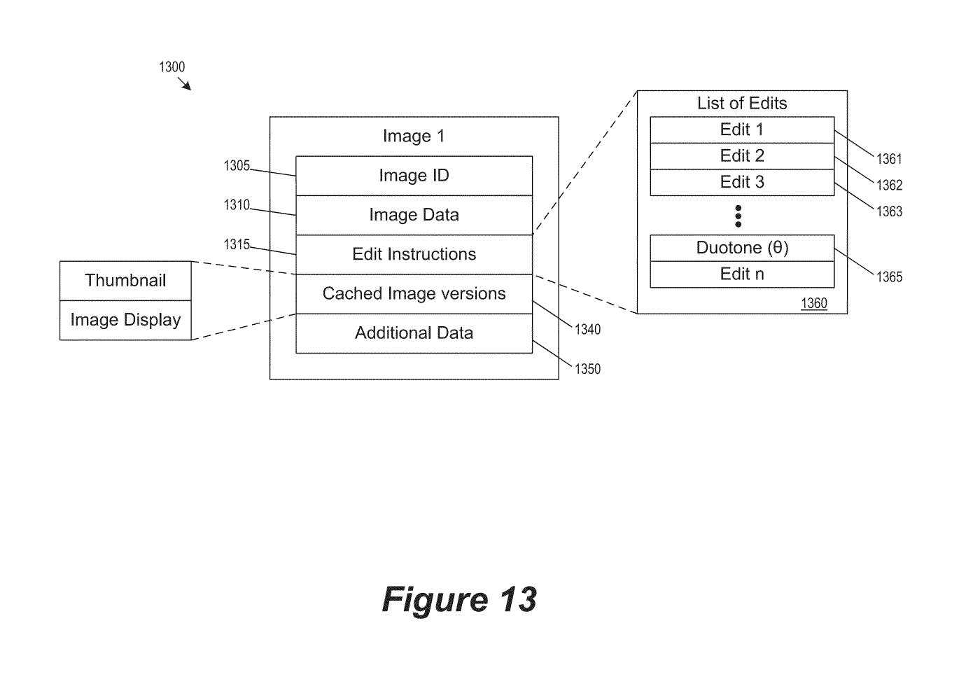

The above-described figures illustrated various examples of the GUI of an image viewing, editing, and organization application of some embodiments. FIG. 12 illustrates a detailed view of a GUI 1200 of some embodiments for viewing, editing, and organizing images. The GUI 1200 will be described in part by reference to FIG. 13, which conceptually illustrates a data structure 1300 for an image as stored by the application of some embodiments.

The data structure 1300 includes an image ID 1305, image data 1310, edit instructions 1315, cached versions 1340 of the image, and any additional data 1350 for the image. The image ID 1305 is a unique identifier for the image, which in some embodiments is used by the collection data structures to refer to the images stored in the collection. The image data 1310 is the actual full-size pixel data for displaying the image (e.g., a series of color-space channel values for each pixel in the image or an encoded version thereof). In some embodiments, this data may be stored in a database of the image viewing, editing, and organization application, or may be stored with the data of another application on the same device. In some embodiments, this additional application is another image organization application that operates on the device, on top of which the image viewing, editing, and organization operates.

Thus, the data structure may store a pointer to the local file associated with the application or an ID that can be used to query the database of another application. In some embodiments, once the application uses the image in a journal or makes an edit to the image, the application automatically makes a local copy of the image file that contains the image data.

The edit instructions 1315 include information regarding any edits the user has applied to the image. In this manner, the application stores the image in a non-destructive format, such that the application can easily revert from an edited version of the image to the original at any time. For instance, the user can apply a duotone effect to the image, leave the application, and then reopen the application and remove the effect at another time. The edits stored in these instructions may be crops and rotations, full-image exposure and color adjustments, localized adjustments, and special effects, as well as other edits that affect the pixels of the image. Some embodiments store these editing instructions in a particular order, so that users can view different versions of the image with only certain sets of edits applied.

In some embodiments, the edit instructions 1315 are implemented as a list 1360 of edit operations. The list 1360 includes edit operations such as edits 1361, 1362, 1363, and 1365. Each edit operation in the list 1360 specifies the necessary parameters for carrying out the edit operation. For example, the edit operation 1365 in the list 1360 specifies an edit to the image that applies a duotone effect with color selection parameter θ.

In some embodiments, the list 1360 records the sequence of edit operations undertaken by the user in order to create the final edited image. In some embodiments, the list 1360 stores the edit instructions in the order that the image editing application applies the edits to the image in order to generate an output image for display, as some embodiments define a particular order for the different possible edits provided by the application. For example, some embodiments define duotone effect as one of the edit operations that are to be applied later than other edit operations such as crop and rotation, full-image exposure, and color adjustment. The list 1360 of some of these embodiments would store the edit instruction for the duotone effect in a position (i.e., edit 1365) that would be applied later than some of the other edit operations (e.g., edits 1361-1363).

The cached image versions 1340 store versions of the image that are commonly accessed and displayed, so that the application does not need to repeatedly generate these images from the full-size image data 1310. For instance, the application will often store a thumbnail for the image as well as a display resolution version (e.g., a version tailored for the image display area). The application of some embodiments generates a new thumbnail for an image each time an edit is applied, replacing the previous thumbnail. Some embodiments store multiple display resolution versions including the original image and one or more edited versions of the image. In some embodiments, the duotone thumbnails in the slider 130 are generated off the cached thumbnail image.

Finally, the image data structure 1300 includes additional data 1350 that the application might store with an image (e.g., locations and sizes of faces, etc.). In some embodiments, the additional data can include Exchangeable image file format (Exif) data, caption data, shared image data, tags on the image or any other types of data. Exif data includes various information stored by the camera that are captured the image such as camera settings, GPS data, timestamps, etc. Caption is a user-entered description of the image. Tags are information that the application enables the user to associate with an image such as marking the image as a favorite, flagged, hidden, etc.

One of ordinary skill in the art will recognize that the image data structure 1300 is only one possible data structure that the application might use to store the required information for an image. For example, different embodiments might store additional or less information, store the information in a different order, etc.

Returning to FIG. 12, the GUI 1200 includes a thumbnail display area 1205, an image display area 1210, a first toolbar 1215, a second toolbar 1220, and a third toolbar 1225. The thumbnail display area 1205 displays thumbnails of the images in a selected collection. Thumbnails are small representations of a full-size image, and represent only a portion of an image in some embodiments. For example, the thumbnails in thumbnail display area 1205 are all squares, irrespective of the aspect ratio of the full-size images. In order to determine the portion of a rectangular image to use for a thumbnail, the application identifies the smaller dimension of the image and uses the center portion of the image in the longer direction. For instance, with a 1600×1200 pixel image, the application would use a 1200×1200 square. To further refine the selected portion for a thumbnail, some embodiments identify a center of all the faces in the image (using a face detection algorithm), then use this location to center the thumbnail portion in the clipped direction. Thus, if the faces in the theoretical 1600×1200 image were all located on the left side of the image, the application would use the leftmost 1200 columns of pixels rather than cut off 200 columns on either side.

After determining the portion of the image to use for the thumbnail, the image-viewing application generates a low resolution version (e.g., using pixel blending and other techniques) of the image. The application of some embodiments stores the thumbnail for an image as a cached version 1340 of the image. Thus, when a user selects a collection, the application identifies all of the images in the collection (through the collection data structure), and accesses the cached thumbnails in each image data structure for display in the thumbnail display area.

The user may select one or more images in the thumbnail display area (e.g., through various touch interactions described above, or through other user input interactions). The selected thumbnails are displayed with a highlight or other indicator of selection. In thumbnail display area 1205, the thumbnail 1230 is selected. In addition, as shown, the thumbnail display area 1205 of some embodiments indicates a number of images in the collection that have been flagged (e.g., having a tag for the flag set to yes). In some embodiments, this text is selectable in order to display only the thumbnails of the flagged images.

The application displays selected images in the image display area 1210 at a larger resolution than the corresponding thumbnails. The images are not typically displayed at the full size of the image, as images often have a higher resolution than the display device. As such, the application of some embodiments stores a cached version 1340 of the image designed to fit into the image display area. Images in the image display area 1210 are displayed in the aspect ratio of the full-size image. When one image is selected, the application displays the image as large as possible within the image display area without cutting off any part of the image. When multiple images are selected, the application displays the images in such a way as to maintain their visual weighting by using approximately the same number of pixels for each image, even when the images have different aspect ratios.

The first toolbar 1215 displays title information (e.g., the name of the collection shown in the GUI, a caption that a user has added to the currently selected image, etc.). In addition, the toolbar 1215 includes a first set of GUI items 1235-1238 and a second set of GUI items 1240-1243.

The first set of GUI items includes a back button 1235, a grid button 1236, a help button 1237, and an undo button 1238. The back button 1235 enables the user to navigate back to a collection organization GUI, from which users can select between different collections of images (e.g., albums, events, journals, etc.). Selection of the grid button 1236 causes the application to move the thumbnail display area on or off of the GUI (e.g., via a slide animation). In some embodiments, users can also slide the thumbnail display area on or off of the GUI via a swipe gesture. The help button 1237 activates a context-sensitive help feature that identifies a current set of tools active for the user and provides help indicators for those tools that succinctly describe the tools to the user. In some embodiments, the help indicators are selectable to access additional information about the tools. Selection of the undo button 1238 causes the application to remove the most recent edit to the image, whether this edit is a crop, color adjustment, etc. In order to perform this undo, some embodiments remove the most recent instruction from the set of edit instructions 1315 stored with the image.

The second set of GUI items includes a sharing button 1240, an information button 1241, a show original button 1242, and an edit button 1243. The sharing button 1240 enables a user to share an image in a variety of different ways. In some embodiments, the user can send a selected image to another compatible device on the same network (e.g., WiFi or Bluetooth network), upload an image to an image hosting or social media website, and create a journal (i.e., a presentation of arranged images to which additional content can be added) from a set of selected images, among others.

The information button 1241 activates a display area that displays additional information about one or more selected images. The information displayed in the activated display area may include some or all of the Exif data stored for an image (e.g., camera settings, timestamp, etc.). When multiple images are selected, some embodiments only display Exif data that is common to all of the selected images. Some embodiments include additional tabs within the information display area for (i) displaying a map showing where the image or images were captured according to the GPS data, if this information is available and (ii) displaying comment streams for the image on any photo sharing websites. To download this information from the websites, the application uses the object ID stored for the image with the shared image data and sends this information to the website. The comment stream and, in some cases, additional information, are received from the website and displayed to the user.

The show original button 1242 enables the user to toggle between the original version of an image and the current edited version of the image. When a user selects the button, the application displays the original version of the image without any of the editing instructions 1315 applied. In some embodiments, the appropriate size image is stored as one of the cached versions 1340 of the image, making it quickly accessible. When the user selects the button again 1242 again, the application displays the edited version of the image, with the editing instructions 1315 applied.

The edit button 1243 allows the user to enter or exit edit mode. When a user has selected one of the sets of editing tools in the toolbar 1220, the edit button 1243 returns the user to the viewing and organization mode, as shown in FIG. 12. When the user selects the edit button 1243 while in the viewing mode, the application returns to the last used set of editing tools in the order shown in toolbar 1220. That is, the items in the toolbar 1220 are arranged in a particular order, and the edit button 1243 activates the rightmost of those items for which edits have been made to the selected image.

The toolbar 1220, as mentioned, includes five items 1245-1249, arranged in a particular order from left to right. The crop item 1245 activates a cropping and rotation tool that allows the user to align crooked images and remove unwanted portions of an image. The exposure item 1246 activates a set of exposure tools that allow the user to modify the black point, shadows, contrast, brightness, highlights, and white point of an image. In some embodiments, the set of exposure tools is a set of sliders that work together in different combinations to modify the tonal attributes of an image. The color item 1247 activates a set of color tools that enable the user to modify the saturation and vibrancy, as well as color-specific saturations (e.g., blue pixels or green pixels) and white balance. In some embodiments, some of these tools are presented as a set of sliders. The brushes item 1248 activates a set of enhancement tools that enable a user to localize modifications to the image. With the brushes, the user can remove red-eye and blemishes, and apply or remove saturation and other features to localized portions of an image by performing a rubbing action over the image. Finally, the effects item 1249 activates a set of special effects that the user can apply to the image. These effects include duotone effect, grainy effect, gradients, tilt shifts, non-photorealistic desaturation effects, grayscale effects, various filters, etc. In some embodiments, the application presents these effects as a set of items that fan out from the toolbar 1225.

As stated, the UI items 1245-1249 are arranged in a particular order. This order follows the order in which users most commonly apply the five different types of edits. Accordingly, the editing instructions 1315 are stored in this same order, in some embodiments. When a user selects one of the items 1245-1249, some embodiments apply only the edits from the tools to the left of the selected tool to the displayed image (though other edits remain stored within the instruction set 1315).

The toolbar 1225 includes a set of GUI items 1250-1254 as well as a settings item 1255. The auto-enhance item 1250 automatically performs enhancement edits to an image (e.g., removing apparent red-eye, balancing color, etc.). The rotation button 1251 rotates any selected images. In some embodiments, each time the rotation button is pressed, the image rotates 90 degrees in a particular direction. The auto-enhancement, in some embodiments, comprises a predetermined set of edit instructions that are placed in the instruction set 1315. Some embodiments perform an analysis of the image and then define a set of instructions based on the analysis. For instance, the auto-enhance tool will attempt to detect red-eye in the image, but if no red-eye is detected then no instructions will be generated to correct it. Similarly, automatic color balancing will be based on an analysis of the image. The rotations generated by the rotation button are also stored as edit instructions.

The flag button 1252 tags any selected image as flagged. In some embodiments, the flagged images of a collection can be displayed without any of the unflagged images. The favorites button 1253 allows a user to mark any selected images as favorites. In some embodiments, this tags the image as a favorite and also adds the image to a collection of favorite images. The hide button 1254 enables a user to tag an image as hidden. In some embodiments, a hidden image will not be displayed in the thumbnail display area and/or will not be displayed when a user cycles through the images of a collection in the image display area. As discussed above by reference to FIG. 13, many of these features are stored as tags in the image data structure.

Finally, the settings button 1255 activates a context-sensitive menu that provides different menu options depending on the currently active toolset. For instance, in viewing mode the menu of some embodiments provides options for creating a new album, setting a key photo for an album, copying settings from one photo to another, and other options. When different sets of editing tools are active, the menu provides options related to the particular active toolset.

One of ordinary skill in the art will recognize that the image viewing and editing GUI 1200 is only one example of many possible graphical user interfaces for an image viewing, editing, and organizing application. For instance, the various items could be located in different areas or in a different order, and some embodiments might include items with additional or different functionalities. The thumbnail display area of some embodiments might display thumbnails that match the aspect ratio of their corresponding full-size images, etc.

### IV. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

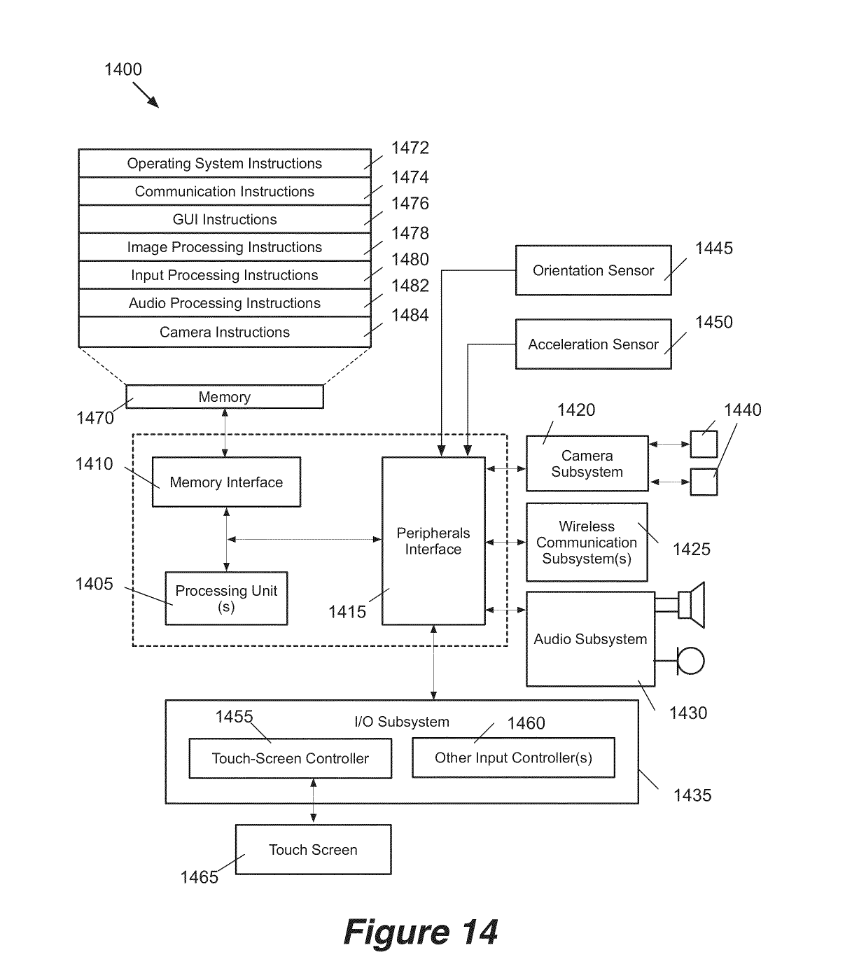

The image editing and viewing applications of some embodiments operate on mobile devices. FIG. 14 is an example of an architecture 1400 of such a mobile computing device. Examples of mobile computing devices include smartphones, tablets, laptops, etc. As shown, the mobile computing device 1400 includes one or more processing units 1405, a memory interface 1410 and a peripherals interface 1415.

The peripherals interface 1415 is coupled to various sensors and subsystems, including a camera subsystem 1420, a wireless communication subsystem(s) 1425, an audio subsystem 1430, an I/O subsystem 1435, etc. The peripherals interface 1415 enables communication between the processing units 1405 and various peripherals. For example, an orientation sensor 1445 (e.g., a gyroscope) and an acceleration sensor 1450 (e.g., an accelerometer) is coupled to the peripherals interface 1415 to facilitate orientation and acceleration functions.

The camera subsystem 1420 is coupled to one or more optical sensors 1440 (e.g., a charged coupled device (CCD) optical sensor, a complementary metal-oxide-semiconductor (CMOS) optical sensor, etc.). The camera subsystem 1420 coupled with the optical sensors 1440 facilitates camera functions, such as image and/or video data capturing. The wireless communication subsystem 1425 serves to facilitate communication functions. In some embodiments, the wireless communication subsystem 1425 includes radio frequency receivers and transmitters, and optical receivers and transmitters (not shown in FIG. 14). These receivers and transmitters of some embodiments are implemented to operate over one or more communication networks such as a GSM network, a Wi-Fi network, a Bluetooth network, etc. The audio subsystem 1430 is coupled to a speaker to output audio (e.g., to output different sound effects associated with different image operations). Additionally, the audio subsystem 1430 is coupled to a microphone to facilitate voice-enabled functions, such as voice recognition, digital recording, etc.

The I/O subsystem 1435 involves the transfer between input/output peripheral devices, such as a display, a touch screen, etc., and the data bus of the processing units 1405 through the peripherals interface 1415. The I/O subsystem 1435 includes a touch-screen controller 1455 and other input controllers 1460 to facilitate the transfer between input/output peripheral devices and the data bus of the processing units 1405. As shown, the touch-screen controller 1455 is coupled to a touch screen 1465. The touch-screen controller 1455 detects contact and movement on the touch screen 1465 using any of multiple touch sensitivity technologies. The other input controllers 1460 are coupled to other input/control devices, such as one or more buttons. Some embodiments include a near-touch sensitive screen and a corresponding controller that can detect near-touch interactions instead of or in addition to touch interactions.

The memory interface 1410 is coupled to memory 1470. In some embodiments, the memory 1470 includes volatile memory (e.g., high-speed random access memory), non-volatile memory (e.g., flash memory), a combination of volatile and non-volatile memory, and/or any other type of memory. As illustrated in FIG. 14, the memory 1470 stores an operating system (OS) 1472. The OS 1472 includes instructions for handling basic system services and for performing hardware dependent tasks.

The memory 1470 also includes communication instructions 1474 to facilitate communicating with one or more additional devices; graphical user interface instructions 1476 to facilitate graphic user interface processing; image processing instructions 1478 to facilitate image-related processing and functions; input processing instructions 1480 to facilitate input-related (e.g., touch input) processes and functions; audio processing instructions 1482 to facilitate audio-related processes and functions; and camera instructions 1484 to facilitate camera-related processes and functions. The instructions described above are merely exemplary and the memory 1470 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 14 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 14 may be split into two or more integrated circuits.

B. Computer System

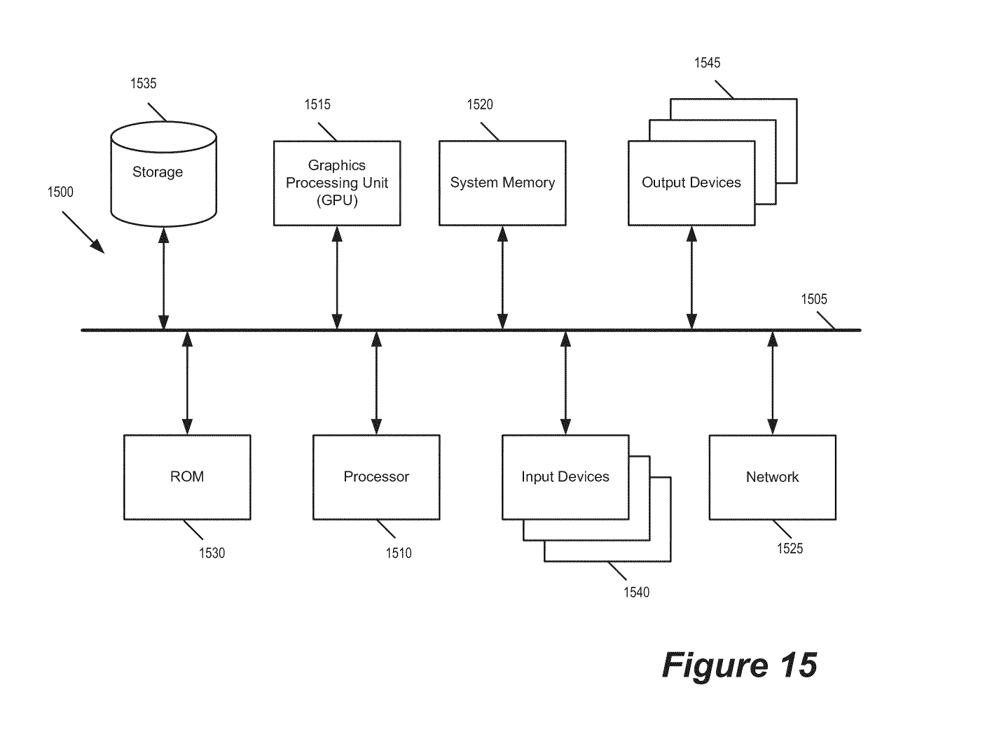

FIG. 15 conceptually illustrates another example of an electronic system 1500 with which some embodiments of the invention are implemented. The electronic system 1500 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1500 includes a bus 1505, processing unit(s) 1510, a graphics processing unit (GPU) 1515, a system memory 1520, a network 1525, a read-only memory 1530, a permanent storage device 1535, input devices 1540, and output devices 1545.

The bus 1505 collectively represents all system, peripheral, and chipset buses that communicatively connect the numerous internal devices of the electronic system 1500. For instance, the bus 1505 communicatively connects the processing unit(s) 1510 with the read-only memory 1530, the GPU 1515, the system memory 1520, and the permanent storage device 1535.

From these various memory units, the processing unit(s) 1510 retrieves instructions to execute and data to process in order to execute the processes of the invention. The processing unit(s) may be a single processor or a multi-core processor in different embodiments. Some instructions are passed to and executed by the GPU 1515. The GPU 1515 can offload various computations or complement the image processing provided by the processing unit(s) 1510. In some embodiments, such functionality can be provided using CoreImage's kernel shading language.

The read-only-memory (ROM) 1530 stores static data and instructions that are needed by the processing unit(s) 1510 and other modules of the electronic system. The permanent storage device 1535, on the other hand, is a read-and-write memory device. This device is a non-volatile memory unit that stores instructions and data even when the electronic system 1500 is off. Some embodiments of the invention use a mass-storage device (such as a magnetic or optical disk and its corresponding disk drive) as the permanent storage device 1535.

Other embodiments use a removable storage device (such as a floppy disk, flash memory device, etc., and its corresponding drive) as the permanent storage device Like the permanent storage device 1535, the system memory 1520 is a read-and-write memory device. However, unlike storage device 1535, the system memory 1520 is a volatile read-and-write memory, such a random access memory. The system memory 1520 stores some of the instructions and data that the processor needs at runtime. In some embodiments, the invention's processes are stored in the system memory 1520, the permanent storage device 1535, and/or the read-only memory 1530. For example, the various memory units include instructions for processing multimedia clips in accordance with some embodiments. From these various memory units, the processing unit(s) 1510 retrieves instructions to execute and data to process in order to execute the processes of some embodiments.

The bus 1505 also connects to the input and output devices 1540 and 1545. The input devices 1540 enable the user to communicate information and select commands to the electronic system. The input devices 1540 include alphanumeric keyboards and pointing devices (also called “cursor control devices”), cameras (e.g., webcams), microphones or similar devices for receiving voice commands, etc. The output devices 1545 display images generated by the electronic system or otherwise output data. The output devices 1545 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 15, bus 1505 also couples electronic system 1500 to a network 1525 through a network adapter (not shown). In this manner, the computer can be a part of a network of computers (such as a local area network (“LAN”), a wide area network (“WAN”), or an Intranet, or a network of networks, such as the Internet. Any or all components of electronic system 1500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). In addition, a number of the figures (including FIGS. 7-9) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

In addition, controls for setting the single adjustment value used to perform different image editing operations are shown as slider controls in FIGS. 1-5. The sliders of such embodiments provide a visual indication of a setting value as a knob is slid along the slider to set a value for the slider. However, in some embodiments, the slider controls shown in any of those figures could be replaced with any other control capable of receiving a value (e.g., a single value), such as a vertical slider control, a pull down menu, a value entry box, an incremental tool activated by keyboard keys, other range related UI controls (e.g., dials, buttons, number fields, and the like), etc. Similarly, the slider controls of those figures are either depicted as being set with a finger gesture (e.g., placing, pointing, tapping one or more fingers) on a touch sensitive screen or simply shown in a position without any indication of how they were moved into position. One of ordinary skill in the art will understand that the controls of FIGS. 1-5 can also be activated and/or set by a cursor control device (e.g., a mouse or trackball), a stylus, keyboard, a finger gesture (e.g., placing, pointing, tapping one or more fingers) near a near-touch sensitive screen, or any other control system in some embodiments. Thus, one of ordinary skill in the art would understand that the invention is not to be limited by the foregoing illustrative details, but rather is to be defined by the appended claims.

What is claimed is:

1. A non-transitory machine readable medium storing a computer program that is executable by at least one processing unit, the computer program comprising sets of instructions for:
receiving a subject image;
receiving a first color selection;
determining a second color selection based on a complementary color of the first color selection; and
using the first and second color selections to generate a duotone image from the received subject image.

2. The non-transitory machine readable medium of claim 1, wherein the computer program comprises a user interface (UI) item for receiving the first color selection, wherein the set of instructions for determining the second color selection comprises a set of instructions for calculating the complementary color based on the first color selection.

3. The non-transitory machine readable medium of claim 2, wherein the UI item comprises a slider.

4. The non-transitory machine readable medium of claim 1, wherein the first color selection is provided by a slider in a graphical user interface (GUI) for selecting a color channel, the slider comprising a plurality of aligned thumbnail images, each thumbnail image occupying a slot that represent a unique range of colors;

5. The non-transitory machine readable medium of claim 4, wherein each thumbnail image in the slider is a duotone thumbnail image based on a thumbnail version of the subject image.

6. The non-transitory machine readable medium of claim 5, wherein each duotone thumbnail image is generated based on a color within the unique range of colors represented by the slot occupied by the duotone thumbnail image in the slider.

7. The non-transitory machine readable medium of claim 5, wherein each duotone thumbnail image is generated based on a color that corresponds to the center of the thumbnail image in the slider.

8. The non-transitory machine readable medium of claim 1, wherein the set of instructions for generating the duotone image comprises a set of instructions for using the first color selection as a highlight color and the second color selection as a shadow color.

9. The non-transitory machine readable medium of claim 1, wherein the first color selection and the second color selection differ by 180 degrees in a color space.

10. The non-transitory machine readable medium of claim 1, wherein the slider spans from 0 degree to 360 degree in the color space.

11. A method of defining an image editing application, the method comprising:
defining a color selection interface; and
defining a duotone effect tool for generating a duotone image of a subject image based on first and second color selections, the first color selection determined by the color selection interface and the second color selection based on a complementary color of the first color selection.

12. The method of claim 11 further comprising calculating the complementary color based on the first color selection.

13. The method of claim 12, wherein the color selection interface comprises a slider.

14. The method of claim 11, wherein the color selection interface comprises a slider, the slider comprising a plurality of aligned thumbnail images, each thumbnail image occupying a slot that represents a unique range of colors.

15. The method of claim 14, wherein each thumbnail image in the slider is a duotone thumbnail image based on a thumbnail version of the subject image.

16. The method of claim 15, wherein each duotone thumbnail image is generated based on a color within the unique range of colors represented by the slot of the duotone thumbnail image in the slider.

17. The method of claim 15, wherein each duotone thumbnail image is generated based on a color that corresponds to the center of the thumbnail image in the slider.

18. The method of claim 14, wherein the slider spans from 0 degree to 360 degree in the color space.

19. The method of claim 11, wherein duotone effect tool uses the first color selection as a highlight color and the second color selection as a shadow color for the duotone image.

20. The method of claim 11, wherein the first color selection and the second color selection differ by 180 degrees in a color space.

21. A method for providing a user interface for generating a duotone image, the method comprising:
providing a slider in a graphical user interface, the slider comprising a plurality of aligned thumbnail images, each thumbnail image occupying a spatial interval that represents a unique range of colors; and
providing a duotone effect tool for generating a duotone image of a subject image based on first and second color selections, the first color selection determined by the slider and the second color selection based on a complementary color of the first color selection.

22. The method of claim 21, wherein each thumbnail image in the slider is a duotone thumbnail image based on a thumbnail version of the subject image.

23. The method of claim 22, wherein each duotone thumbnail image is generated based on a color within the unique range of colors represented by the spatial interval of the duotone thumbnail image in the slider.

24. The method of claim 22, wherein each duotone thumbnail image is generated based on a color that corresponds to the center of the thumbnail image in the slider.

25. The method of claim 21, wherein duotone effect tool uses the first color selection as a highlight color and the second color selection as a shadow color for the duotone image.

26. The method of claim 21, wherein the first color selection and the second color selection differ by 180 degrees in a color space.

27. The method of claim 21, wherein the slider spans from 0 degree to 360 degree in the color space.

28. An image editing application comprising:
a thumbnail generation module for generating a slider in a graphical user interface, the slider comprising a plurality of aligned thumbnail images, each thumbnail image occupying a spatial interval that represents a unique range of colors;
an image processing module for generating a duotone image based on first and second color selection, the first color selection determined by the slider and the second color selection based on a complementary color of the first color selection;
a display module for displaying the generated slider and the generated duotone image.

29. The image editing application of claim 28, wherein each thumbnail image in the slider is a duotone thumbnail image based on a thumbnail version of the subject image.

30. The image editing application of claim 29, wherein each duotone thumbnail image is generated based on a color within the unique range of colors represented by the spatial interval of the duotone thumbnail image in the slider.

31. The image editing application of claim 29, wherein each duotone thumbnail image is generated based on a color that corresponds to the center of the thumbnail image in the slider.

32. The image editing application of claim 28, wherein duotone effect tool uses the first color selection as a highlight color and the second color selection as a shadow color for the duotone image.

33. The image editing application of claim 28, wherein the first color selection and the second color selection differ by 180 degrees in a color space.

34. The image editing application of claim 28, wherein the slider spans from 0 degree to 360 degree in the color space.
